(19) United States
(12) Patent Application Publication
(10) Pub. No.: US 2005/0287466 A1
(43) Pub. Date: Dec. 29, 2005

(54) Negative-working photosensitive composition and negative-working photosensitive planographic printing plate

(76) Inventors: Yasushi Miyamoto, Tatebayashi-shi (JP); Eiji Hayakawa, Sumiyoshi-cho (JP)

Correspondence Address: FAEGRE & BENSON;ATTN: PATENT DOCKING, 2200 WELLS FARGO CENTER, 90 SOUTH 7TH STREET, MINNEAPOLIS, MN, 55402-3901, US

(21) Appl. No.: 10/524,097

(22) PCT Filed: Aug. 13, 2003
(86) PCT No.: PCT/JP03/10320

§ 371 Date: Feb. 9, 2005

(30) Foreign Application Priority Data
Aug. 13, 2002 (JP) 2002-236009

(51) Int. Cl. G03C 1/492

(52) U.S. Cl. 430/141

(57) ABSTRACT

A negative-working photosensitive composition comprises (a) an alkali-soluble resin, (b) a compound which causes a crosslinking reaction by an acid, (c) a compound which generates an acid by heating, and (d) a photothermal converting agent, wherein the compound (c) which generates an acid by heating described above is an onium salt of an acidic dye having a sulfonic group in a molecule. A negative-working photosensitive planographic printing plate is provided with a photosensitive layer comprising the negative-working photosensitive composition, on a surface of a support.

### TECHNICAL FIELD

The present invention relates to a negative-working photosensitive composition and a negative-working photosensitive planographic printing plate used in the field of offset printing. In particular, the present invention is concerned with a negative-working photosensitive planographic printing plate used as a so-called computer-to-plate (CTP) capable of directly forming a plate by means of a laser corresponding to a digital signal from a computer or the like, and a negative-working photosensitive composition which is suitably employed in a photosensitive layer of the negative-working photosensitive planographic printing plate described above.

### BACKGROUND ART

With progress in computer image processing techniques, methods for directly inscribing an image by irradiation with light corresponding to a digital signal have recently been developed. Intense interest has been shown towards a computer-to-plate (CTP) system for directly forming an image on a photosensitive planographic printing plate without outputting to a silver salt mask film, by utilizing this system in a planographic printing plate. The CTP system using a high-output laser having a maximum intensity within a near infrared or infrared range as a light source for irradiation with light has such advantages that a high-resolution image can be obtained by exposure in a short time and a photosensitive planographic printing plate used in the system can be handled in a daylight room. In particular, high-output, small lasers are readily available as solid lasers and semiconductor lasers, which emit infrared rays having a wavelength in a range of from 760 nm to 1200 nm.

As the negative-working photosensitive composition which can form an image using the solid laser or semiconductor laser capable of emitting infrared light, a photosensitive composition comprising an alkali-soluble resin (such as a novolak resin), a compound which causes a crosslinking reaction by an acid (an acid crosslinking agent such as a resol resin), a compound which generates an acid by heating (an acid generating agent), and a photothermal converting agent (an infrared absorber such as a dye or pigment) is proposed in Japanese Unexamined Patent Application, First Publication No. Hei 7-20629 A.

In the negative-working photosensitive composition described above, a negative-working image may be formed as described below. First, an infrared light emitted from the solid laser or semiconductor laser is converted into heat by means of the photothermal converting agent. By virtue of the heat, an acid is generated by the acid generating agent. Subsequently, when a pre-heating (heating) before developing is carried out, the acid crosslinking agent causes a crosslinking reaction with the alkali-soluble resin or with the acid crosslinking agent per se, by means of catalysis of the acid, thereby resulting in insolubilization in an alkali developer. Thereby, a negative-working image is formed.

However, the negative-working photosensitive composition has poor storage stability. After a photosensitive planographic printing plate employing the negative-working photosensitive composition is stored at high temperatures and high humidity, an image is formed on the photosensitive planographic printing plate, and is developed, followed by printing. In this case, there was a problem in that staining may occur in non-image portions due to poor development.

As a photosensitive planographic printing plate with improved storage stability, the printing plate in which an onium salt compound having a sulfonic acid as a counterion is employed as an acid generating agent is described in Japanese Unexamined Patent Application, First Publication No. Hei 10-39509, and the printing plate in which a sulfonic salt of a specified iodonium ion is employed as an acid generating agent is described in Japanese Unexamined Patent Application, First Publication No. Hei 11 -84654. However, storage stability of the photosensitive planographic printing plates described above was insufficient.

In addition, there was a problem in that the photothermal converting agent included in the negative-working photosensitive composition increased ablation (phenomenon of components of a photosensitive composition, and in particular, the acid generating agent, vaporizing off due to heating) at the time of exposure. The ablation results in contamination of a light source such as a solid laser, a semiconductor laser, or the like. For this reason, it is desirable that ablation be controlled.

In addition, in the photosensitive planographic printing plate in which the negative-working photosensitive composition is employed in the photosensitive layer, the pH of the photosensitive layer is changed by an acid which is generated by the acid generating agent, and a basic dye which is separately added for a different purpose from that of a photothermal converting agent causes a change in color tone. Thereby, a difference in color between the exposed part of the photosensitive layer of the photosensitive planographic printing plate and the unexposed part thereof is generated, so that the exposed image can be seen. However, in the conventional photosensitive planographic printing plates, there was a problem in that the difference in the color between the exposed part of the photosensitive layer and the unexposed part thereof is small, so that it is difficult to see the exposed image (degradation of visible image quality at the time of exposure).

### DISCLOSURE OF THE INVENTION

Therefore, objects of the present invention are to provide a negative-working photosensitive composition which has superior storage stability, can control ablation at the time of exposure, and can provide a coating film having good visible image quality at the time of exposure, and to provide a negative-working photosensitive planographic printing plate capable of directly forming a plate by means of a laser corresponding to a digital signal from a computer or the like, and which has superior storage stability, can control ablation at the time of exposure, and can provide good visible image properties at the time of exposure.

That is, a negative-working photosensitive composition of the present invention is characterized by comprising (a) an alkali-soluble resin, (b) a compound which causes a crosslinking reaction by an acid, (c) a compound which generates an acid by heating, and (d) a photothermal converting agent, wherein the compound (c) which generates an acid by heating described above is an onium salt of an acidic dye having a sulfonic group in the molecule thereof.

It is desirable that the acidic dye having the sulfonic group in the molecule, described above, have 21 or more carbon atoms in the molecule.

A negative-working photosensitive planographic printing plate of the present invention is characterized by comprising a photosensitive layer comprising the negative-working photosensitive composition according to the present invention, on a surface of a support.

### BEST MODE FOR CARRYING OUT THE INVENTION

In the following, the present invention is described in detail.

(Negative-Working Photosensitive Composition)

“An alkali-soluble resin (a)” refers to a binder resin which is insoluble in water and is soluble in an alkali aqueous solution. Examples thereof include a resin having an alkali-soluble group such as a carboxyl group, a phenolic hydroxyl group, a sulfonic group, a phosphone group, an active imino group, an N-sulfonylamide group, or the like.

As examples of the alkali-soluble resin (a), mention may be made of, for example, novolak resins or resol resins such as a phenol/formaldehyde resin, a cresol/formaldehyde resin, a phenol/cresol/formaldehyde co-condensed resin, and the like; polyhydroxystyrenes; polyhalogenated hydrostyrenes; acrylic resins comprising one or more kinds of monomers having an acidic group such as N-(4-hydroxyphenyl)methacrylamide, hydroquinone monomethacrylate, N-(sulfamoylphenyl)methacrylamide, N-phenylsulfonylmethacrylamide, N-phenylsulfonylmaleimide, acrylic acid, methacrylic acid, and the like; resins containing active methylene groups; vinyl polymer resins such as a resin containing an urea bond; polyurethane resins having a N-sulfonylamide group, a N-sulfonylureide group, or a N-aminosulfonylamide group; polyurethane resins such as a polyurethane resin containing an active imino group, and the like; polyamide resins such as a polyhydroxypolyamide, and the like; polyester resins such as a polyester resin having a phenolic hydroxyl group; and the like.

Among these resins, novolak resins are preferably employed in view of providing a broad developing latitude.

The used amount of the alkali-soluble resin (a) preferably ranges from 40 to 95% by mass with respect to the solid content of the negative-working photosensitive composition. In addition, two or more kinds of the alkali-soluble resins (a) may be simultaneously employed, if necessary.

The compound (b) which causes a crosslinking reaction by an acid is not particularly limited, as long as the compounds crosslink with the alkali-soluble resin (a) or crosslink with the compound (b) which causes a crosslinking reaction by an acid, by catalysis of an acid generated from the compound (c) which generates an acid by heating, described below, and can make the alkali-soluble resin (a) or the compound (b) which causes a crosslinking reaction by an acid, insoluble with respect to an alkali developer.

As an example of the compound (b) which causes a crosslinking reaction by an acid, mention may be made of, for example, an amino compound having at least two groups from among a methylol group, an alkoxymethyl group, an acetoxymethyl group, and the like. As specified examples thereof, mention may be made of, for example, melamine derivatives, urea resin derivatives, resol resins, and the like, such as methoxymethylated melamine, benzoguanamine derivatives, or glycoluril derivatives.

Among these, resol resins are preferably employed in view of solubility in the developer of the image portion and non-image portion, and an increase in contrast.

The amount of the compound (b) used which causes a crosslinking reaction by an acid preferably ranges from 5 to 70% by mass with respect to the solid content of the negative-working photosensitive composition. In addition, two or more kinds of the compound (b) which causes a crosslinking reaction by an acid may be simultaneously employed, if necessary.

The compound (c) which generates an acid by heating in the present invention is an onium salt of an acidic dye having a sulfonic group in the molecule thereof.

Here, the acidic dye means an aqueous dye comprising a color acid having an acidic group such as a sulfonic group, a carboxylic group, or the like in a molecule, and is commonly employed as a sodium salt. Therefore, the “onium salt of an acidic dye having a sulfonic group in a molecule” in the present invention means a salt of a color acid having a sulfonic group in a molecule, and having a diazonium ion, an iodonium ion, a sulfonium ion, or the like, instead of a sodium ion, as a cation.

The onium salt of the acidic dye having a sulfonic group in the molecule described above can be produced by mixing a commercially available acidic dye having a sulfonic group in the molecule (mainly a sodium salt) with an onium salt compound such as a diazonium salt, an iodonium salt, a sulfonium salt, or the like, in the state of an aqueous solution, followed by filtering the formed precipitation.

As representative examples of the commercially available acidic dye having a sulfonic group in a molecule, mention may be made of, for example, Acid Red 350 (Formula (I-1) described below), Acid Blue 114 (I-2), Benzo Indigo Blue (I-3), Direct Brown 202 (I-4), Acid Green 5 (I-5), Food Green 2 (I-5), Acid Blue 34 (I-6), Acid Blue 90 (I-7), Acid Green 25(I-8), Anthraquinone Green GX (I-9), Acid Red 81 (I-10), and Acid Blue 80 (I-11).

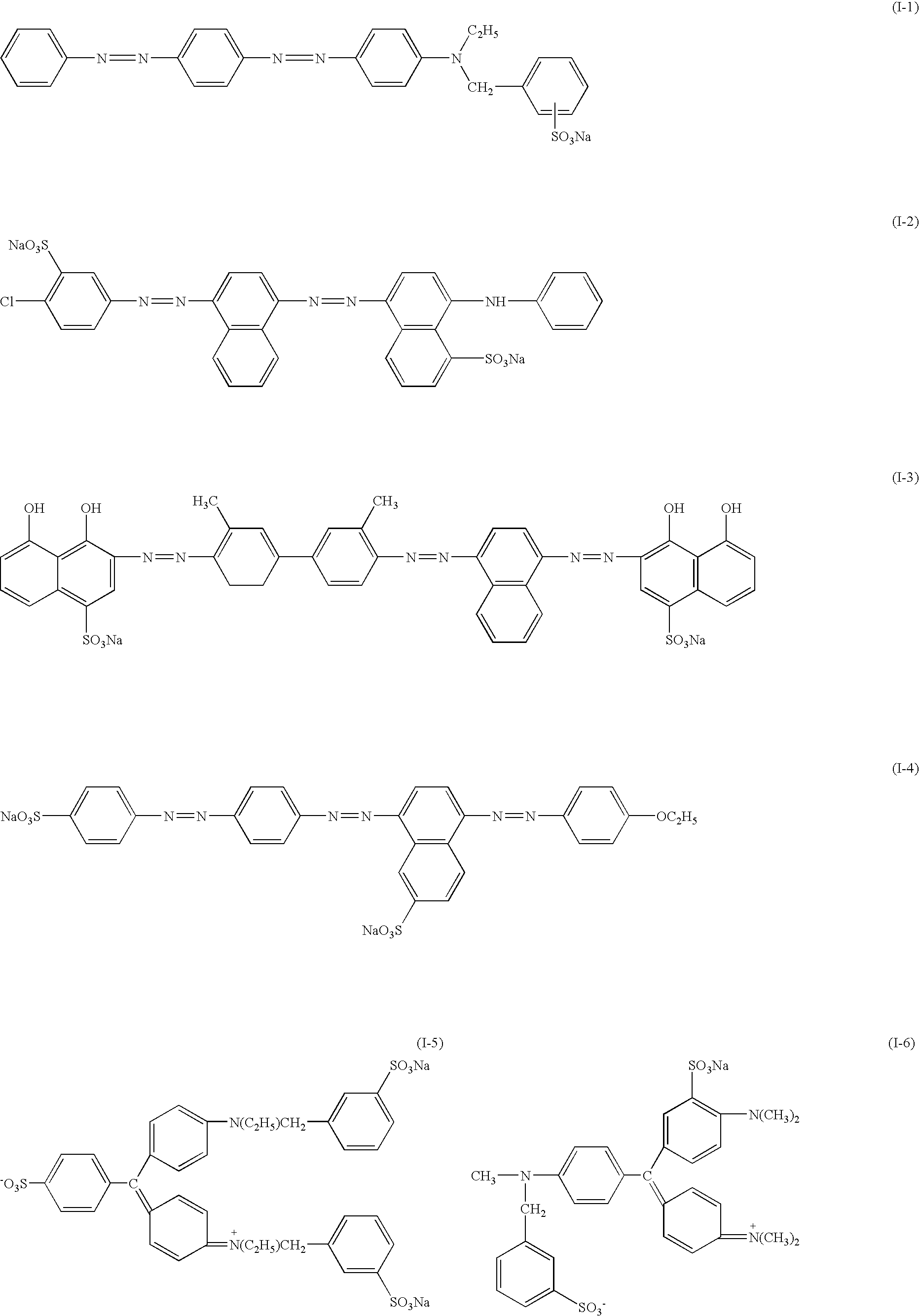

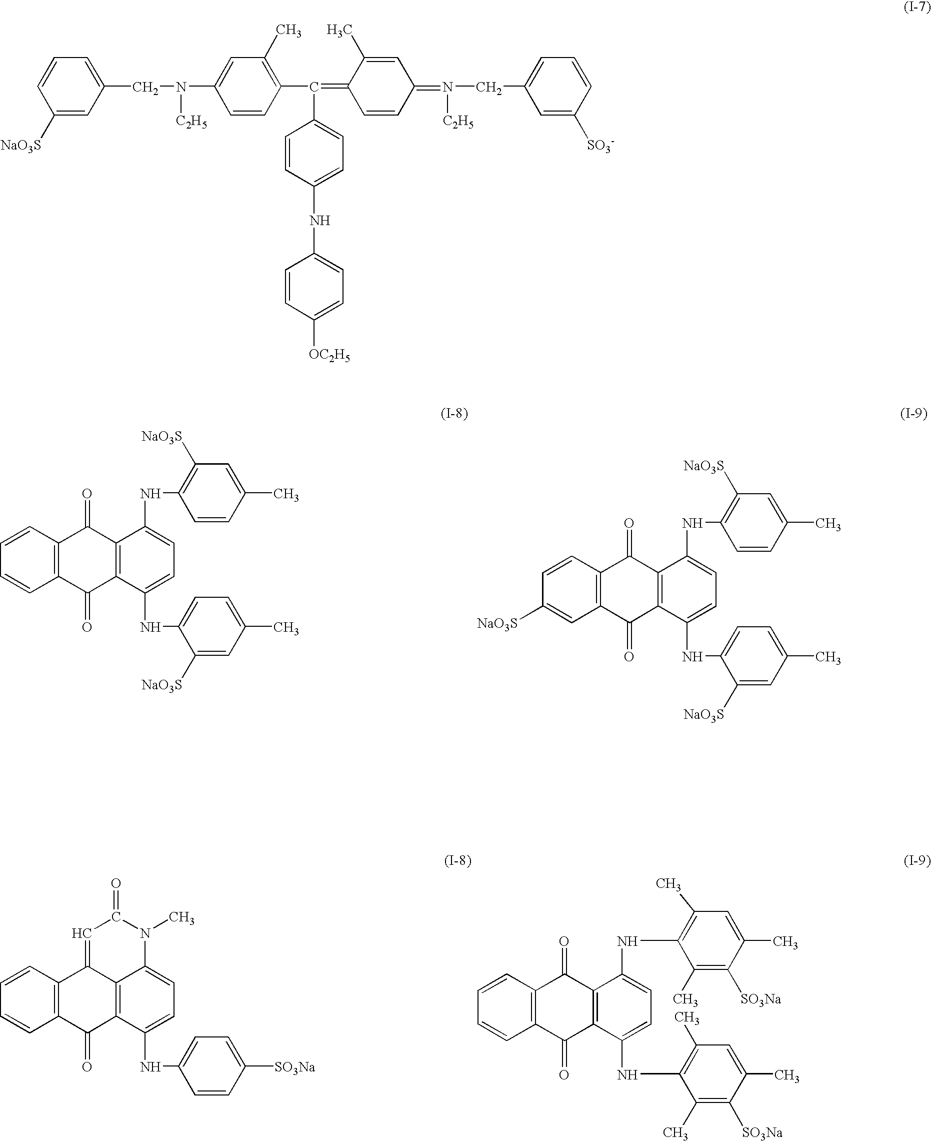

In addition to these dyes, as examples of the acidic dye having a sulfonic group in the molecule, mention may be made of, for example, Acid Violet 2, Acid Blue 113, Acid Black 24, Direct Red 116, Direct Violet 41, Direct Blue 29, Direct Green 23, Direct Brown 14, Acid Blue 103, Acid Green 22, Acid Violet 17, Acid Green 27, Acid Violet 34, Spirit Fast Blue G, Acid Yellow 65, Acid Yellow 40, and the like.

In addition, as the acidic dye having a sulfonic group in the molecule thereof, those having 21 or more carbon atoms in the molecule are preferable. By having 21 or more carbon atoms in the molecule, the molecular weight of the onium salt of the acidic dye having a sulfonic group in the molecule is increased, so that thermal stability of the onium salt is improved, and thereby, storage stability of a coating film formed from the negative-working photosensitive composition is further enhanced. In addition, the molecular weight of the onium salt of the acidic dye having a sulfonic group in the molecule is increased, so that vaporization of the onium salt due to heat can be controlled, and ablation of the coating film formed from the negative-working photosensitive composition is further controlled.

In addition, as the acidic dye having a sulfonic group in the molecule thereof, blue or green dyes are preferable since they provide superior plate inspection properties and superior checkability.

As examples of the cation of onium salt of the acidic dye having a sulfonic group in the molecule thereof, mention may be made of a diazonium ion, an iodonium ion, and a sulfonium ion. As examples of the diazonium salt, mention may be made of, for example, those represented by Formulae (II-1) to (II-23) described below. As examples of the iodonium salt, mention may be made of, for example those represented by Formulae (III-1) to (III-10). As examples of the sulfonium salt, mention may be made of, for example, those represented by Formulae (IV-1) to (IV-19).

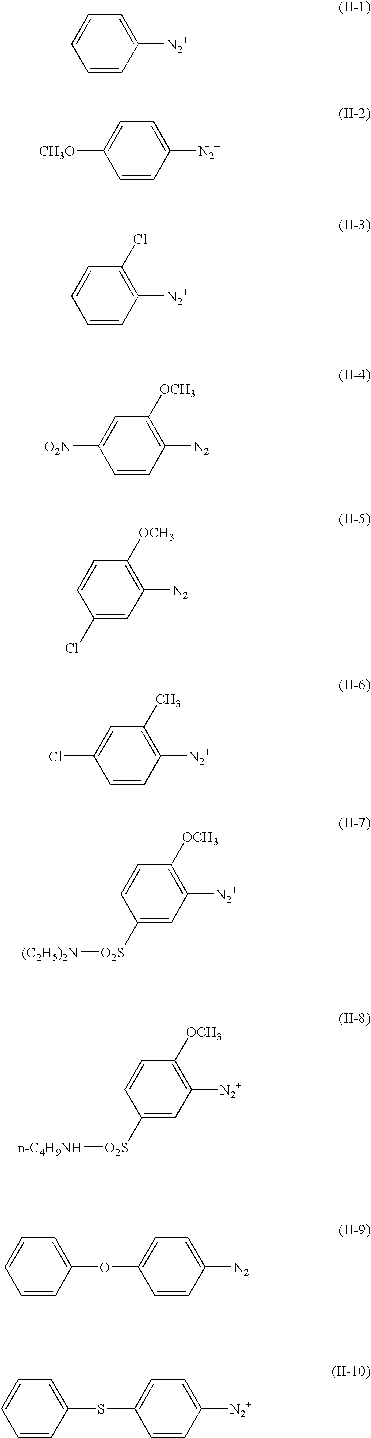

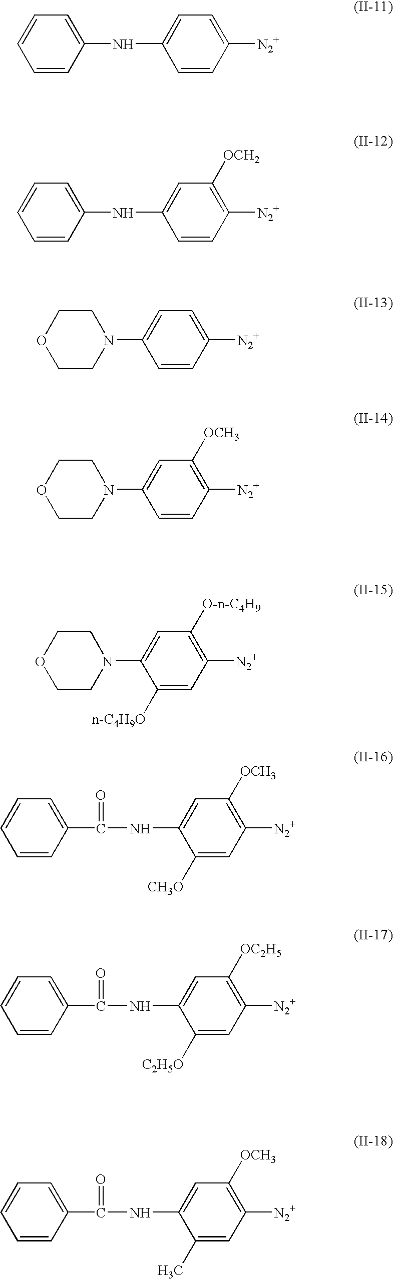

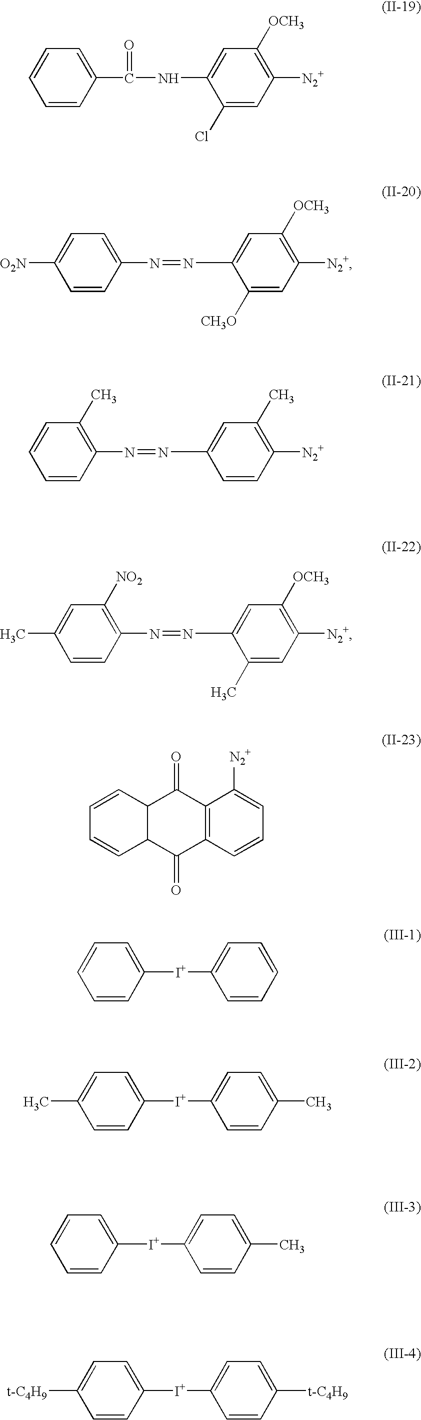

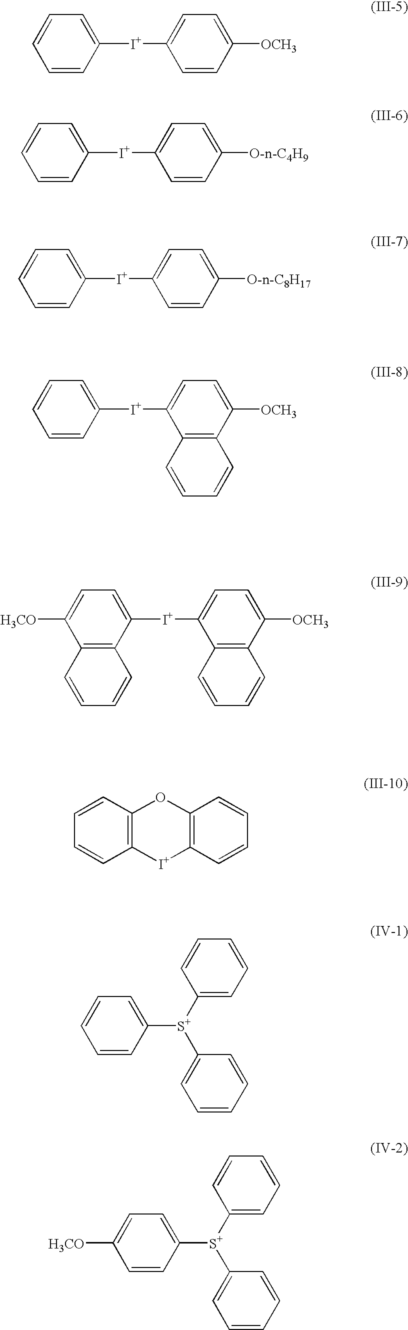

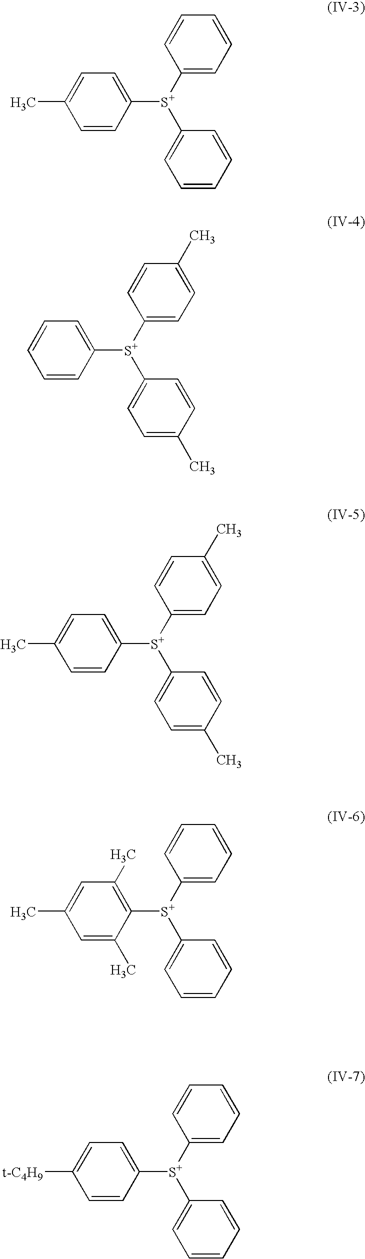

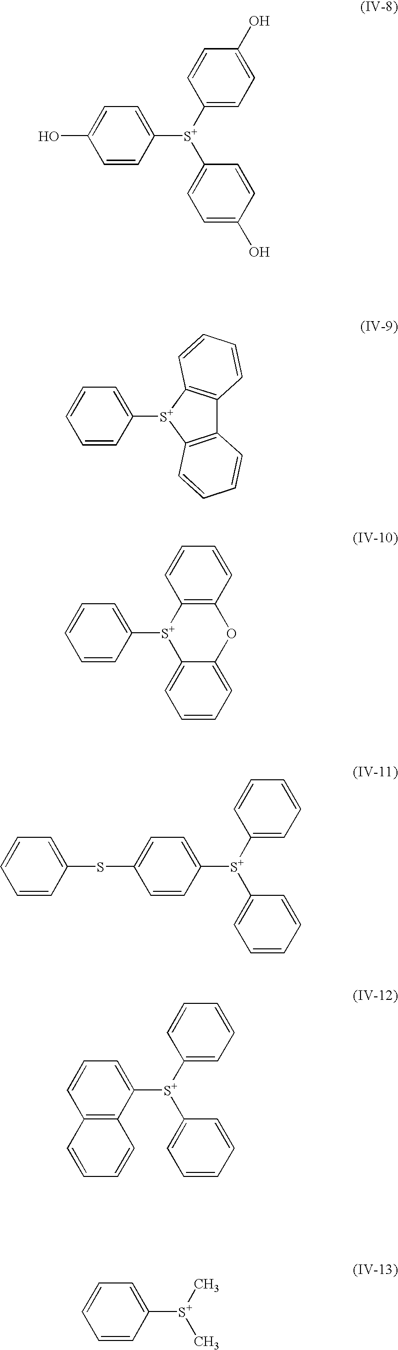

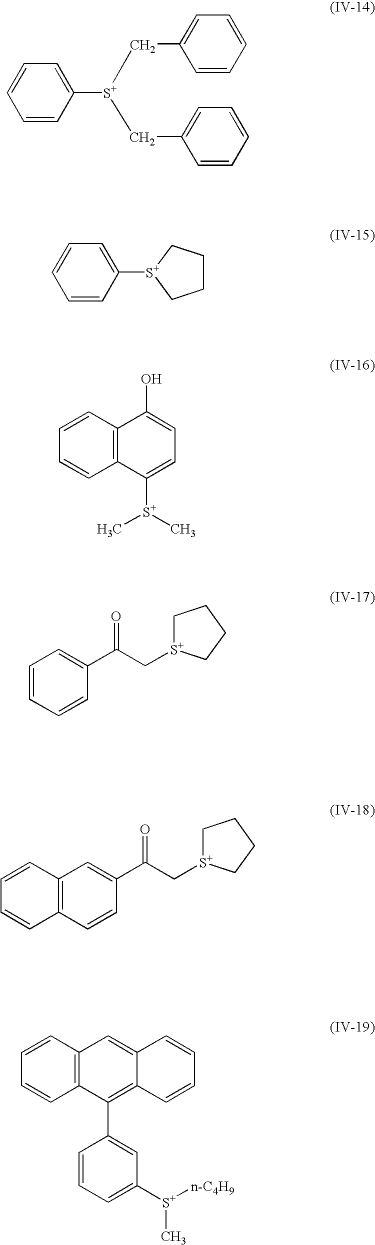

The compounds (c) which generate an acid by heat may be employed in combination of two or more kinds thereof, if necessary.

In addition, conventional compounds which generate an acid by heating, other than the onium salts of the acidic dyes having a sulfonic group in the molecule described above, can be simultaneously employed within a range which does not adversely affect the objects of the present invention. As examples of other compounds which generate an acid by heating, mention may be made of conventional onium salts such as an ammonium salt, a phosphonium salt, an iodonium salt, a sulfonium salt, a selenonium salt, and the like, trihaloalkyl compounds, photo acid generators having an o-nitrobenzyl type protective group, disulfone compounds, and the like.

As examples of the trihaloalkyl compounds, mention may be made of, for example, trihalomethyl-s-triazine compounds, oxadiazole compounds, tribromomethylsulfonyl compounds, and the like.

The employed amount of the compound (c) which generates an acid by heating preferably ranges from 0.01 to 50% by mass, and, in particular, preferably ranges from 0.1 to 20% by mass, with respect to the solid content of the negative-working photosensitive composition. If the employed amount of the compound (c) which generates an acid by heating is less than 0.01% by mass, it is not possible to expect sufficient generation of an acid required to crosslink the alkali-soluble resin with the compound (b) which causes a crosslinking reaction by an acid, or crosslink the compounds (b) which cause a crosslinking reaction by an acid, themselves. On the other hand, if the amount exceeds 50% by mass, the solubility in a developer of the non-image portion is drastically reduced.

The photothermal converting agent (d) is a substance which absorbs light to generate heat. As examples of the substance, for example, various pigments and dyes may be mentioned.

As the pigments employed in the present invention, commercially available pigments, and pigments described in color index handbook “New Pigment Handbook, edited by the Pigment Technology Society of Japan, 1977”, “New Pigment Application Technology” (CMC Publishing Co., Ltd., 1986), “Printing Ink Technology” (CMC Publishing Co., Ltd., 1984), and the like can be utilized. As kinds of pigments, mention may be made black pigments, yellow pigments, orange pigments, brown pigments, red pigments, violet pigments, blue pigments, green pigments, fluorescent pigments, and other polymer bonded pigments. Specifically, insoluble azo pigments, azo lake pigments, condensed azo pigments, chelate azo pigments, phthalocyanine pigments, anthraquinone pigments, perylene and perinone pigments, thioindigo pigments, quinacridon pigments, dioxazine pigments, isoindolinone pigments, quinophthalon pigments, dyeing lake pigments, azine pigments, nitroso pigments, nitro pigments, natural pigments, fluorescent pigments, inorganic pigments, carbon black, and the like can be employed.

Among these pigments, in particular, carbon black is preferably employed as a substance which absorbs light in the near infrared to infrared range to efficiently generate heat and is economically superior. In addition, as the carbon blacks described above, grafted carbon blacks with various functional groups, having good dispersing properties, are commercially available. For example, those described on page 167 of “Carbon Black Handbook, the 3^{rd} edition” (edited by the Carbon Black Society, 1995), page 111 of “Characteristics of Carbon Black, Optimal Blend, and Utilization Technology” (the Technology Information Society, 1997), and the like. All of these can be suitably employed in the present invention.

These pigments may be employed without being subjected to a surface treatment, or may be employed after being subjected to a publicly known surface treatment. Examples of the method for publicly known surface treatments include a method of coating the surface with a resin or wax, a method of adhering a surfactant to the surface, and a method of combining a reactive substance such as a silane coupling agent, an epoxy compound, or a polyisocyanate, with the surface of the pigment. The surface treatment methods described above are described in “Properties of Metallic Soaps and Application Thereof” (Saiwai Shobo), “New Pigment Application Technology” (CMC Publishing Co., Ltd., 1986), “Printing Ink Technology” (CMC Publishing Co., Ltd., 1984), and the like.

The particle size of the pigment used in the present invention is preferably in the range of from 0.01 to 15 micrometers, and is more preferably in the range of from 0.01 to 5 micrometers.

As the dye used in the present invention, common dyes which are publicly known can be employed. As examples thereof, mention may be made of, for example, those described in “Dye Handbook” (edited by the Organic Synthesis Chemistry Society, 1970 (Showa 45)), “Color Material Technology Handbook” (edited by the Color Material Society, Asakura Shoten, 1989), “Technology of Pigments for Use in Industries and Markets Thereof” “CMC Publishing Co., Ltd., 1983), and “Chemistry Handbook, Applied Chemistry Edition” (edited by the Chemical Society of Japan, Maruzen Co., Ltd., 1986). As specified examples thereof, mention may be made of an azo dye, a metal chain salt azo dye, a pyrazolone azo dye, an anthraquinone dye, a phthalocyanine dye, a carbonium dye, a quinone imine dye, a methine dye, a cyanine dye, an indigo dye, a quinoline dye, a nitro dye, a xanthene dye, a thiazine dye, an azine dye, an oxazine dye, and the like. Among these dyes, those absorbing light in the near infrared to infrared range are particularly preferable.

As examples of dyes absorbing light in the near infrared to infrared range, mention may be made of, for example, a cyanine dye, a methine dye, a naphthoquinone dye, a squarylium pigment, an aryl benzo(thio)pyridinium salt, a trimethine thiapyrylium salt, a pyrylium compound, a pentamethine thiopyrylium salt, an IR-absorbing dye, and the like.

As the photothermal converting agent (d), at least one kind of pigment or dye, which can absorb light having a specific wavelength from the light source described below and can convert light into heat, is employed by appropriately selecting from the above pigments or dyes, and adding to a negative-working photosensitive composition.

In the case of using the pigment as the photothermal converting agent (d), the employed amount thereof is preferably in the range of from 1 to 70% by mass, and is particularly preferably in the range of from 3 to 50% by mass, with respect to the total solid content of the negative-working photosensitive composition. If the employed amount of the pigment is less than 1% by mass, sufficient quantity of heat cannot be provided even if the pigment absorbs light and then generates heat. On the other hand, if the employed amount is more than 70% by mass, the amount of heat tends to be too great, and for this reason, it is not preferable.

In the case of using the dye as the photothermal converting agent (d), the employed amount thereof is preferably in the range of from 0.1 to 30% by mass, and is particularly preferably in the range of from 0.5 to 20% by mass, with respect to the total solid content of the negative-working photosensitive composition. If the employed amount of the dye is less than 0.1% by mass, sufficient quantity of heat cannot be provided even if the pigment absorbs light and then generates heat. On the other hand, if the employed amount is more than 30% by mass, the generated quantity of heat is in the saturated state, and an increase in the effects does not tend to occur. Therefore, it is not preferable.

In the negative-working photosensitive compositions of the present invention, conventional additives such as coloring materials (dyes and pigments), surfactants, plasticizers, and stability modifiers can be added.

As examples of suitable dyes, mention may be made of, for example, basic oil-soluble dyes such as Crystal Violet, Malachite Green, Victoria Blue, Methylene Blue, Ethyl Violet, Rhodamine B, and the like. As examples of commercially available products, mention may be made of, for example, “Victoria Pure Blue BOH” (manufactured by Hodogaya Chemical Co., Ltd.), “Oil Blue #603” (manufactured by Orient Chemical Industries, Ltd.), “VPB-Naps” (naphthalene sulfonic salt of Victoria Pure Blue) (manufactured by Hodogaya Chemical Co., Ltd.), “D11” (manufactured by PCAS Co., Ltd.), and the like. As examples of the pigment, mention may be made of, for example, Phthalocyanine Blue, Phthalocyanine Green, Dioxadine Violet, Quinacridon Red, and the like.

As examples of the surfactants, mention may be made of fluorine surfactants, silicone surfactants, and the like.

As examples of the plasticizers, mention may be made of, for example, diethyl phthalate, dibutyl phthalate, dioctyl phthalate, tributyl phosphate, trioctyl phosphate, tricresyl phosphate, tri(2-chloroethyl) phosphate, tributyl citrate, and the like.

Furthermore, as publicly known stability modifiers, for example, phosphoric acid, phosphorous acid, oxalic acid, tartaric acid, malic acid, citric acid, dipicolinic acid, polyacrylic acid, benzenesulfonic acid, and toluenesulfonic acid can also be employed in combination.

The added amount of these additives varies depending on the purpose, but is preferably, in general, in the range of 0 to 30% by mass with respect to the solid content of the photosensitive composition.

In the negative-working photosensitive compositions described above, since an onium salt of an acidic dye having a sulfonic group in the molecule is employed as a compound (c) which generates an acid by heating, superior storage stability can be provided, ablation at the time of exposure can be controlled, and a coating film having good visible image properties at the time of exposure can be obtained. That is, the acidic dye having a sulfonic group in the molecule, which is the counterion of the onium ion, has a relatively high molecular weight, and for this reason, the molecular weight of the onium salt of the acidic dye having a sulfonic group in the molecule is also high, so that heat stability of the onium salt is improved, and thereby, the storage stability of the coating film formed from the negative-working photosensitive composition can be enhanced. In addition, since the molecular weight of the onium salt of the acidic dye having a sulfonic group in the molecule is also high, vaporization of the onium salt due to heat can be controlled, and ablation of the coating film formed from the negative-working photosensitive composition can be controlled. In addition, the acid generated from the onium salt effectively reacts with the acidic dye having a sulfonic group in the molecule, which is the counterion thereof, and the color difference between the exposed part of the coating film formed from the negative-working photosensitive composition and the unexposed part thereof tends to be enhanced, resulting in improvement of visible image properties.

(Negative-Working Photosensitive Planographic Printing Plate)

The negative-working photosensitive planographic printing plate of the present invention is generally composed of a substrate, and a photosensitive layer formed from the above photosensitive composition provided on the substrate.

The photosensitive layer may be referred to as a heat-sensitive layer because it utilizes heat generated by irradiation with light, but is here referred to as a photosensitive layer for convenience.

Examples of the substrate include metal plates made of aluminum, zinc, copper, stainless steel, iron, or the like; plastic films made of polyethylene terephthalate, polycarbonate, polyvinyl acetal, polyethylene, or the like; composite materials such as a paper melt-coated with a synthetic resin or coated with a synthetic resin solution or those obtained by providing a metal layer on a plastic film using a technology such as vacuum deposition or lamination; and materials used as the substrate of the printing plate. Among these substrates, an aluminum substrate and a composite substrate coated with aluminum are preferably employed.

The surface of the aluminum substrate is preferably subjected to a surface treatment for the purpose of enhancing water retention and improving the adhesion with the photosensitive layer. Examples of the surface treatment include, for example, brushing, ball polishing, electrolytic etching, chemical etching, liquid honing, a roughening treatment such as sand blasting, and combinations thereof. Among these, a roughening treatment including use of the electrolytic etching is preferable.

In the electrolytic bath used during the electrolytic etching, an aqueous solution containing an acid, an alkali, or a salt thereof, or an aqueous solution containing an organic solvent is used. Among these, an electrolytic solution containing hydrochloric acid, nitric acid, or a salt thereof is, in particular, preferable.

Furthermore, if necessary, the aluminum substrate subjected to the roughening treatment is further subjected to a desmutting treatment using an aqueous solution of an acid or alkali. The aluminum substrate thus obtained is preferably anodized. In particular, an anodizing treatment performed in a bath containing sulfuric acid or phosphoric acid is preferable.

In addition, if necessary, the aluminum substrate can be subjected to a silicate treatment (sodium silicate, potassium silicate), a treatment with potassium zirconate fluoride, a phosphomolybdate treatment, an alkyl titanate treatment, a polyacrylate treatment, a polyvinyl sulfonic acid treatment, a phosphonic acid treatment, a phytic acid treatment, a treatment with a salt of a hydrophilic organic polymer compound and a divalent metal, a hydrophilization treatment by means of undercoating of a water-soluble polymer having a sulfonic acid group, a coloring treatment with an acidic dye, and a treatment such as silicate deposition.

It is preferable that the aluminum substrate be subjected to a sealing treatment after a roughening treatment (graining treatment) and an anodizing treatment. The sealing treatment is performed by dipping the aluminum substrate in hot water or a hot aqueous solution containing an inorganic salt or an organic salt, or by employing a steam bath.

The negative-working photosensitive planographic printing plate of the present invention is produced by applying a negative-working photosensitive coating solution, prepared by dissolving or dispersing a negative-working photosensitive composition in an organic solvent, on the surface of a substrate, and drying the coating solution to form a photosensitive layer on the substrate.

As the organic solvent in which the negative-working photosensitive composition is dissolved or dispersed, any publicly known and conventional organic solvents can be employed. Among these, an organic solvent having a boiling point in the range of from 40° C. to 200° C., and particularly from 60° C. to 160° C., is selected in view of advantages during drying.

As examples of organic solvents, mention may be made of, for example, alcohols such as methyl alcohol, ethyl alcohol, n- or isopropyl alcohol, n- or isobutyl alcohol, and diacetone alcohol; ketones such as acetone, methyl ethyl ketone, methyl propyl ketone, methyl butyl ketone, methyl amyl ketone, methyl hexyl ketone, diethyl ketone, diisobutyl ketone, cyclohexanone, methylcyclohexanone, and acetylacetone; hydrocarbons such as hexane, cyclohexane, heptane, octane, nonane, decane, benzene, toluene, xylene, and methoxybenzene; acetate esters such as ethyl acetate, n- or isopropyl acetate, n- or isobutyl acetate, ethylbutyl acetate, and hexyl acetate; halides such as methylene dichloride, ethylene dichloride, and monochlorobenzene; ethers such as isopropyl ether, n-butyl ether, dioxane, dimethyldioxane, and tetrahydrofuran; polyhydric alcohols and derivatives thereof, such as ethylene glycol, methylcellosolve, methylcellosolve acetate, ethylcellosolve, diethylcellosolve, cellosolve acetate, butylcellosolve, butylcellosolve acetate, methoxymethoxy ethanol, diethylene glycol monomethyl ether, diethylene glycol dimethyl ether, diethylene glycol methyl ethyl ether, diethylene glycol diethyl ether, propylene glycol, propylene glycol monomethyl ether, propylene glycol monomethyl ether acetate, propylene glycol monoethyl ether, propylene glycol monoethyl ether acetate, propylene glycol monobutyl ether, 3-methyl-3-methoxybutanol, and 1-methoxy-2-propanol; and special solvents such as dimethyl sulfoxide, N,N-dimethylformamide, methyl lactate, and ethyl lactate. These organic solvents are employed alone or in combination therewith. The concentration of the solid content in the negative-working photosensitive composition to be applied is suitably controlled in the range of from 2 to 50% by mass.

As the coating method of the negative-working photosensitive composition, for example, the methods such as roll coating, dip coating, air knife coating, gravure coating, gravure offset coating, hopper coating, blade coating, wire doctor coating, and spray coating can be employed. The coating amount of the negative-working photosensitive composition is preferably in the range of from 10 ml/m² to 100 ml/m².

The negative-working photosensitive composition applied on the substrate is usually dried by means of heated air. The heating is performed at a temperature preferably ranging from 30 to 200° C., and particularly preferably ranging from 40 to 140° C. Not only a method of maintaining the drying temperature at the same temperature during drying, but also a method of raising the temperature stepwise, can be carried out.

In addition, preferable results may be obtained by dehumidification of the drying air. The heated air is supplied to the surface to be coated at a rate preferably ranging from 0.1 m/sec to 30 m/sec, and particularly preferably ranging from 0.5 m/sec to 20 m/sec.

The coating amount of the photosensitive composition is usually in the range of from about 0.5 to about 5 g/m² on a dry mass basis.

The negative-working photosensitive planographic printing plate of the present invention can be used as a so-called computer-to-plate (CTP) which can directly write an image on a plate based on digital information from the computer using a laser.

As examples of the light source of the laser employed in the present invention, mention may be made of various semiconductor lasers wherein the oscillation wavelength is in the range of from 300 nm to 950 nm, a carbon dioxide laser (oscillation wavelength: 10.6 nm), a YAG laser (oscillation wavelength: 532 nm, 1064 nm), an excimer laser (oscillation wavelength: 193 nm, 308 nm, 351 nm), an Ar laser (488 nm), and the like. Any laser can be employed by selecting the pigments or dye, which can absorb light having a specific wavelength of the light source to convert light into heat, among those described above, and adding them to the negative-working photosensitive composition.

In the present invention, since the negative-working photosensitive planographic printing plate can be treated in a daylight room, a high output laser having maximum intensity in the near infrared to infrared range is most preferably employed. As examples of high output lasers having the maximum intensity in the near infrared to infrared range, mention may be made of various lasers having the maximum intensity in the near infrared to infrared range of from 760 nm to 3000 nm, such as a semiconductor laser, and a YAG laser.

The photosensitive planographic printing plate of the present invention is fromed by writing an image on a photosensitive layer using a laser, subsequently carrying out a developing treatment thereon, and removing the non-image portion using a wet method to provide a planographic printing plate having an image portion. As examples of the developer used in the developing treatment, mention may be made of an alkali aqueous solution (basic aqueous solution), and the like.

Examples of the alkali agent used in the developer include, for example, inorganic alkali compounds such as sodium silicate, potassium silicate, potassium hydroxide, sodium hydroxide, lithium hydroxide, a sodium, potassium, or ammonium salt of secondary or tertiary phosphoric acid, sodium metasilicate, sodium carbonate, and ammonia; and organic alkali compounds such as monomethylamine, dimethylamine, trimethylamine, monoethylamine, diethylamine, triethylamine, monoisopropylamine. diisopropylamine, n-butylamine, di-n-butylamine, monoethanolamine, diethanolamine, triethanolamine, ethyleneimine, and ethylenediamine.

The content of the alkali agent in the developer is preferably in the range of from 0.005 to 10% by mass, and particularly preferably in the range of from 0.05 to 5% by mass. If the content of the alkali agent in the developer is less than 0.005% by mass, the development tends to be poor. On the other hand, if the amount is more than 10% by mass, an adverse effect such as corrosion of the image portion tends to be exerted during the development. Therefore, they are not preferred.

An organic solvent can be added to the developer. As examples of the organic solvent which can be added to the developer, mention may be made of, for example, ethyl acetate, butyl acetate, amyl acetate, benzyl acetate, ethylene glycol monobutyl acetate, butyl lactate, butyl levulinate, methyl ethyl ketone, ethyl butyl ketone, methyl isobutyl ketone, cyclohexanone, ethylene glycol monobutyl ether, ethylene glycol monobenzyl ether, ethylene glycol monophenyl ether, benzyl alcohol, methyl phenyl carbitol, n-amyl alcohol, methylamyl alcohol, xylene, methylene dichloride, ethylene dichloride, and monochlorobenzene.

The amount of the organic solvent to be added to the developer is preferably not more than 20% by mass, and, in particular, preferably not more than 10% by mass.

Furthermore, in the developers described above, for example, if necessary, water-soluble sulfites such as lithium sulfite, sodium sulfite, potassium sulfite, and magnesium sulfite; aromatic hydroxy compounds such as an alkali-soluble pyrazolone compound, an alkali-soluble thiol compound, and methylresorcinol; water softeners such as a polyphosphoric salt and an aminopolycarboxylic acid; and various surfactants such as anionic surfactants, nonionic surfactants, cationic surfactants, amphoteric surfactants, and fluorine surfactants such as sodium isopropylnaphthalene sulfonate, sodium n-butylnaphthalene sulfonate, sodium N-methyl-N-pentadecyl aminoacetate, and sodium lauryl sulfate, and various defoamers can be employed.

As the developer, commercially available developers for negative-working PS plates or positive-working PS plates can be practically used. Specifically, a developer prepared by diluting a commercially available concentrated developer for negative-working PS plates or positive-working PS plates, 1 to 1000 times, can be used as the developer in the present invention.

The temperature of the developer is preferably in the range of from 15 to 40° C., while the dipping time is preferably in the range of from 1 second to 2 minutes. If necessary, it is possible to slightly rub the surface during development.

After completion of the development, the planographic printing plate is subjected to washing with water and/or is subjected to a treatment with an aqueous desensitizer. The aqueous desensitizer includes, for example, an aqueous solution of a water-soluble natural polymer such as gum arabic, dextrin, or carboxymethylcellulose, or an aqueous solution of a water-soluble synthetic polymer such as polyvinyl alcohol, polyvinyl pyrrolidone, or polyacrylic acid. If necessary, an acid or a surfactant is added to the aqueous desensitizer. After the treatment with the desensitizer is carried out, the planographic printing plate is dried, and is subsequently employed as a printing plate for printing.

In the negative-working photosensitive planographic printing plates described above, since an onium salt of an acidic dye having a sulfonic group in the molecule is employed as a compound (c) which generates an acid by heating, contained in the photosensitive layer, superior storage stability can be provided, ablation at the time of exposure can be controlled, and good visible image properties at the time of exposure can be obtained. That is, the acidic dye having a sulfonic group in the molecule, which is the counterion of the onium ion, has a relatively high molecular weight, and for this reason, the molecular weight of the onium salt of the acidic dye having a sulfonic group in the molecule is also high, so that heat stability of the onium salt is improved, and thereby, the storage stability of the negative-working photosensitive planographic printing plate can be enhanced. In addition, since the molecular weight of the onium salt of the acidic dye having a sulfonic group in the molecule is high, vaporization of the onium salt due to heat can be controlled, and ablation of the negative-working photosensitive planographic printing plates can be controlled. In addition, the acid generated from the onium ion effectively reacts with a sulfonic group in the molecule of the acidic dye, which is the counterion thereof, color difference between the exposed part of the photosensitive layer and the unexposed part thereof tends to be enhanced, resulting in improvement of visible image properties of the negative-working photosensitive planographic printing plates.

The negative-working photosensitive planographic printing plates of the present invention can be employed for various purposes, such as a photoresist, in addition to the planographic printing plate.

### EXAMPLES

The present invention will be described in more detail by way of Examples. It should be understood that the present invention is not limited to the following Examples.

The onium salts of the acidic dyes having a sulfonic group were synthesized as described below.

### Synthesis of 3-methoxy-4-diazo-diphenylamine Acid Green 25 Salt

A solution produced by dissolving 14.7 g of 3M4DSS (manufactured by Fuji Pigment, Co., Ltd.) corresponding to a diazonium salt in 300 g of water was mixed with a solution produced by dissolving 16.7 g of Acid Green 25 (manufactured by Aldrich Co., Ltd.) in 200 g of water, followed by stirring the mixture for 24 hours at room temperature. The precipitated green precipitates were filtered, were washed with water, and were dried, thus producing 3-methoxy-4-diazo-diphenylamine Acid Green 25 salt represented by Formula (V) described below.

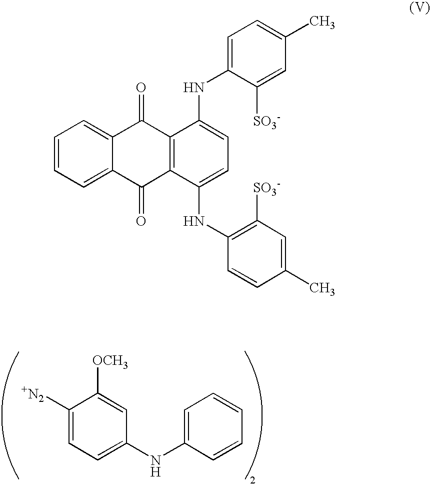

### Synthesis of 3-methoxy-4-diazo-diphenylamine Acid Blue 80 Salt

A solution produced by dissolving 14.7 g of 3M4DSS (manufactured by Fuji Pigment, Co., Ltd.) corresponding to a diazonium salt in 300 g of water was mixed with a solution produced by dissolving 22.1 g of Acid Blue 80 (manufactured by Aldrich Co., Ltd.) in 200 g of water, followed by stirring the mixture for 24 hours at room temperature. The precipitated green precipitates were filtered, were washed with water, and were dried, thus producing 3-methoxy-4-diazo-diphenylamine Acid Blue 80 salt represented by Formula (VI) described below.

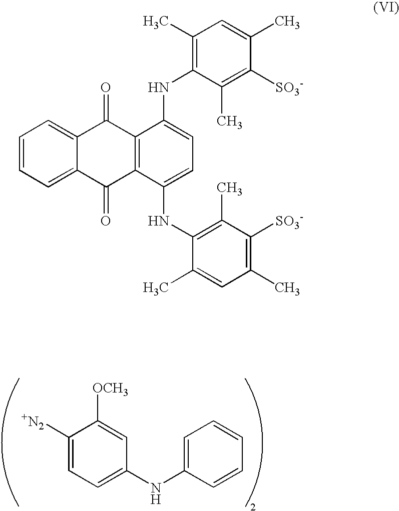

### Synthesis of diphenyliodonium Acid Green 25 Salt

A solution produced by dissolving 10.2 g of diphenyliodonium chloride (manufactured by Aldrich Co., Ltd.) in a mixed solvent consisting of 300 g of water and 300 g of methanol was mixed with a solution produced by dissolving 11.6 g of Acid Green 25 (manufactured by Aldrich Co., Ltd.) in 200 g of water, followed by stirring the mixture for 24 hours at room temperature. After methanol is removed under reduced pressure, the precipitated green precipitates were filtered, were washed with water, and were dried, thus producing diphenyliodonium Acid Green 25 salt represented by Formula (VII) described below.

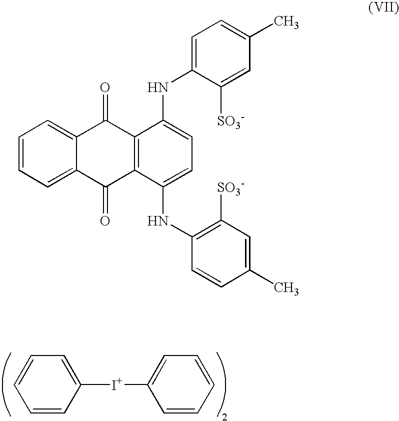

### Example 1

As shown in the composition table of Table 1, 5.0 g of a m-cresol novolak resin (N-13P, manufactured by Eastman Kodak Company) as an alkali-soluble resin (a), 3.5 g of a resol resin (Phenolite ZF-7234, bisphenol A type, manufacture by DAINIPPON INK & CHEMICALS Co., Ltd.) as a compound (b) which causes a crosslinking reaction by an acid, 0.6 g of 3-methoxy-4-diazo-diphenylamine Acid Green 25 salt as a compound (c) which generates an acid by heating, 0.6 g of a cyanine dye A represented by Formula (VIII) described below and 0.2 g of a cyanine dye B represented by Formula (IX) described below as a photothermal converting agent (d), and 0.6 g of DC190 (a 10% solution, manufactured by Eastman Kodak Company) as a surfactant were dissolved in a solvent consisting of 45.0 g of methylcellosolve and 45.0 g of methyl ethyl ketone, thus producing a coating solution of a negative-working photosensitive composition.

TABLE 1

| Coating solution of a negative-working photosensitive | | | | Comparative | | |
|---|---|---|---|---|---|---|
| composition | Example | | | Example | | |
| Unit: g | 1 | 2 | 3 | 1 | 2 | 3 |
| Methylcellosolve | 45.0 | 45.0 | 45.0 | 45.0 | 45.0 | 45.0 |
| Methyl ethyl ketone | 45.0 | 45.0 | 45.0 | 45.0 | 45.0 | 45.0 |
| Resol resin (bisphenol A type) | 3.5 | 3.5 | 3.5 | 3.5 | 3.5 | 3.5 |
| m-cresol novolak resin | 5.0 | 5.0 | 5.0 | 5.0 | 3.5 | 3.5 |
| 3-methoxy-4-diazophenylamine p-toluenesulfonate | | | | 0.6 | 0.6 | |
| Diphenyliodonium p-toluenesulfonate | | | | | | 0.6 |
| 3-methody-4-diazo-diphenylamine Acid Green 25 salt | 0.6 | | | | | |
| 3-methody-4-diazo-diphenylamine Acid Blue 80 salt | | 0.6 | | | | |
| Diphenyliodonium Acid Green 25 salt | | | 0.6 | | | |
| Cyanine dye A | 0.6 | 0.6 | 0.6 | 0.6 | 0.6 | 0.6 |
| Cyanine dye B | 0.2 | 0.2 | 0.2 | 0.2 | 0.2 | 0.2 |
| D11 | | | | 0.1 | | 0.1 |
| Acid Green 25 | | | | | 0.1 | |
| DC190 (10% solution) | 0.6 | 0.6 | 0.6 | 0.6 | 0.6 | 0.6 |

| | |
|---|---|
| | (VIII) |
| 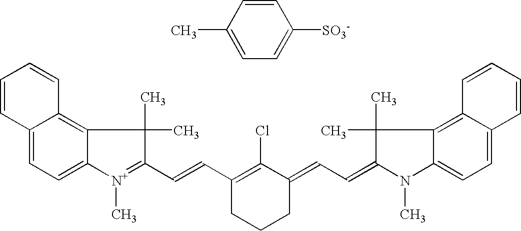 | |
| | (IX) |
| 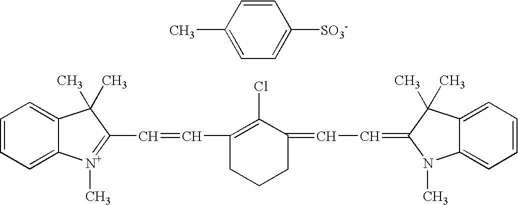 | |

An aluminum plate having a thickness of 0.24 mm was degreased with an aqueous solution of sodium hydroxide, and was then electrolytically grained in a 20% hydrochloric acid bath to obtain a grained sheet having a center line average roughness (Ra) of 0.5 μm. Subsequently, the resulting grained sheet was anodized in a 20% sulfuric acid bath at a current density of 2 A/dm² to form an oxidized film of 2.7 g/m², and was subsequently washed with water, thus producing an aluminum substrate. The coating solution of the negative-working photosensitive composition was applied on the substrate using a roll coater, and was subsequently dried for 2 minutes at 100° C., thus producing a negative-working photosensitive planographic printing plate. The coating mass after drying was 1.5 g/m².

(Ablation Amount)

Ten negative-working photosensitive planographic printing plates (size: 300 mm×500 mm) produced above were subjected to flood laser exposure by means of an exposing machine comprising a near infrared semiconductor laser mounted therein (Trendsetter, manufactured by Creo) (wavelength: 830 nm, laser power: 8 W, revolution speed: 140 rpm). Subsequently, the filter was withdrawn, and the degree of contamination was evaluated. The evaluation results of the ablation amount are shown in Table 2. In the evaluation criteria, “A” indicates a small degree of ablation and “C” indicates a large degree of ablation.

(Visible Image Property)

The produced photosensitive planographic printing plate was subjected to laser exposure by means of an exposing machine comprising a near infrared semiconductor laser mounted therein (Trendsetter, manufactured by Creo) (wavelength: 830 nm, laser power: 8 W, revolution speed: 140 rpm). The optical density (a) of the unexposed part and the optical density (b) of the exposed part were measured by means of an optical densitometer, RD-917 (manufactured by Macbeth Co., Ltd.). The color difference was calculated in accordance with the equation, □OD=(b)−(a). The results are shown in Table 3.

(Storage Stability)

Using the photosensitive planographic printing plate immediately after it was produced, image exposure was carried out by means of an exposing machine comprising a near infrared semiconductor laser mounted therein (Trendsetter, manufactured by Creo) (wavelength: 830 nm, laser power: 8 W, revolution speed: 140 rpm). Subsequently, using a Winsconsin oven (feeding rate: 2.5 feet/min), preheating was carried out for one minute at a specified preheating temperature. Subsequently, the planographic printing plate was developed using a developer (a dilution produced by diluting PD1R, manufactured by Kodak Polychrome Graphics Co., Ltd., with water 5 times) by means of an autoprocessor (PK-910, manufactured by Kodak Polychrome Graphics Co., Ltd.) for 25 seconds at 30° C.

As the setting of the preheating temperature was gradually increased, the same operations as described above were carried out until development deterioration occurred, and the preheating temperature when the development deterioration occurred was recorded as “fog temperature”.

Subsequently, with respect to the photosensitive planographic printing plate stored for 2 days at 50° C. and the photosensitive planographic printing plate stored for 4 days at 50° C., the fog temperatures were obtained in the same manner as described above. The change (dropping) in fog temperature based on that of the photosensitive planographic printing plate immediately after it was produced are shown in Table 4.

### Examples 2 and 3 and Comparative Examples 1 to 3

The negative-working photosensitive planographic printing plates were produced in the same manner as described in Example 1, except that the compositions of the coating solution were changed into those shown in Table 1, and were evaluated. The evaluation results are shown in Tables 2 to 4. Here, D11 which is a basic dye has a structure represented by Formula (X) described below.

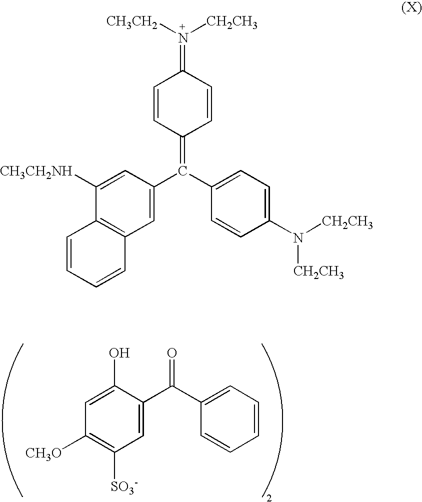

TABLE 2

| | | | | Comparative | | |
|---|---|---|---|---|---|---|
| | Example | | | Example | | |
| | 1 | 2 | 3 | 1 | 2 | 3 |
| Ablation amount | A | A | A | B | B | B |

TABLE 3

| | Example | | | Comparative Example | | |
|---|---|---|---|---|---|---|
| | 1 | 2 | 3 | 1 | 2 | 3 |
| ΔOD | 0.12 | 0.10 | 0.03 | 0.05 | 0.05 | 0.01 |

TABLE 4

| | | | | Comparative | | |
|---|---|---|---|---|---|---|
| | Example | | | Example | | |
| | 1 | 2 | 3 | 1 | 2 | 3 |
| Heating for 2 days at 50° C. | 1° F. | 1° F. | 1° F. | 1° F. | 1° F. | 1° F. |
| Heating for 4 days at 50° C. | 2° F. | 2° F. | 2° F. | 4° F. | 4° F. | 4° F. |

As is apparent from the results shown in Tables 2 to 4, it can be seen that in Examples 1 to 3 in which the onium salt of the acidic dye having a sulfonic group in the molecule is employed as a compound (c) which generates an acid by heating, the ablation amount is small, the color difference between the exposed part and the unexposed part is large, good visible image properties are exhibited, and decrease of the fogging temperature after storage at increased temperatures is small, resulting in superior storage stability.

### INDUSTRIAL APPLICABILITY

As described above, the negative-working photosensitive composition of the present invention comprises (a) the alkali-soluble resin, (b) the compound which causes a crosslinking reaction by an acid, (c) the compound which generates an acid by heating, and (d) the photothermal converting agent, and the compound (c) which generates an acid by heating described above is an onium salt of an acidic dye having a sulfonic group in the molecule thereof. For this reason, superior storage stability is exhibited, ablation at the time of exposure can be controlled, and a coating film having good visible image properties at the time of exposure can be obtained.

In addition, when the acidic dye having a sulfonic group in the molecule described above has 21 or more carbon atoms in the molecule, the storage stability of the obtained coating film is further improved, and ablation at the time of exposure can be further controlled.

In addition, in the negative-working photosensitive planographic printing plate of the present invention, a photosensitive layer comprising the negative-working photosensitive composition of the present invention is provided on a surface of a support. For this reason, directly forming a plate by means of a laser corresponding to a digital signal from a computer or the like can be performed, superior storage stability is exhibited, ablation at the time of exposure is controlled, and good visible image properties at the time of exposure are exhibited.

1. A negative-working photosensitive composition comprising
(a) an alkali-soluble resin,
(b) a crosslinking agent crosslinkable by an acid,
(c) a compound that generates an acid upon heating, wherein the compound is an onium salt of an acidic dye having a sulfonic group within the molecule, and
(d) a photothermal converting agent.

2. (canceled)

3. (canceled)

4. The composition of claim 1, wherein the alkali-soluble resin comprises a novolak resin.

5. The composition of claim 1, wherein the composition comprises from 40 to 95 percent, by mass, of the alkali-soluble resin.

6. The composition of claim 1, wherein the crosslinking agent comprises a resol resin.

7. The composition of claim 1, wherein the composition comprises from 5 to 70 percent, by mass, of the crosslinking agent.

8. The composition of claim 1, wherein the acidic dye having the sulfonic group has 21 or more carbon atoms in the molecule.

9. The composition of claim 1, wherein the onium salt is a diazonium, iodonium, or sulfonium salt.

10. The composition of claim 1, wherein the composition comprises from 0.01 to 50 percent, by mass, of the compound that generates an acid upon heating.

11. The composition of claim 1, wherein the composition comprises from 0.1 to 20 percent, by mass, of the compound that generates an acid upon heating.

12. The composition of claim 1, comprising a mixture of compounds that generate acid upon heating.

13. The composition of claim 1, wherein the photothermal converting agent absorbs light in the near infrared to infrared region.

14. The composition of claim 1, wherein the composition comprises from 3 to 50 percent, by mass, of a pigment as the photothermal converting agent.

15. The composition of claim 1, wherein the composition comprises from 0.5 to 20 percent, by mass, of a dye as the photothermal converting agent.

16. A printing plate precursor comprising:
a substrate; and
a photosensitive layer on the substrate, the photosensitive layer comprising
(a) an alkali-soluble resin,
(b) a crosslinking agent crosslinkable by an acid,
(c) a compound that generates an acid upon heating, wherein the compound is an onium salt of an acidic dye having a sulfonic group within the molecule, and
(d) a photothermal converting agent.

17. The printing plate precursor of claim 16, wherein the precursor is sensitive to light in the near infrared to infrared region.

18. The printing plate precursor of claim 16, wherein the alkali-soluble resin comprises a novolak resin.

19. The printing plate precursor of claim 16, wherein the crosslinking agent comprises a resol resin.

20. The printing plate precursor of claim 16, wherein the acidic dye having the sulfonic group has 21 or more carbon atoms in the molecule.

21. A method for making a printing plate precursor having a photosensitive layer on a substrate, the method comprising:
(i) providing a substrate; and
(ii) applying to a surface of the substrate a composition comprising
(a) an organic solvent,
(b) an alkali-soluble resin,
(c) a crosslinking agent crosslinkable by an acid,
(d) a compound that generates an acid upon heating, wherein the compound is an onium salt of an acidic dye having a sulfonic group within the molecule, and
(e) a photothermal converting agent; and
(iii) drying the composition to form a photosensitive layer on the substrate.

22. The method of claim 21, wherein the acidic dye having the sulfonic group has 21 or more carbon atoms in the molecule.
